(19) United States
(12) Patent Application Publication
(10) Pub. No.: US 2017/0206817 A1
(43) Pub. Date: Jul. 20, 2017

(54) ELECTRONIC PRODUCT AND LOGO DISPLAY METHOD AND SYSTEM THEREOF

(71) Applicant: SHENZHEN SKYWORTH-RGB ELECTRONIC CO., LTD., Shenzhen (CN)

(72) Inventors: Kun XU, SHENZHEN (CN); Zhenghua LU, SHENZHEN (CN); Xuefeng LIU, SHENZHEN (CN); Zhao LI, SHENZHEN (CN)

(21) Appl. No.: 15/328,317

(22) PCT Filed: Jan. 6, 2016
(86) PCT No.: PCT/CN2016/070271

§ 371 Date: Jan. 23, 2017

(30) Foreign Application Priority Data
Sep. 8, 2015 (CN) 201510564766.7

(51) Int. Cl. G09G 3/00; H04N 9/31

(52) U.S. Cl. CPC G09G 3/002; H04N 9/317; H04N 9/3152; G09G 2354/00

(57) ABSTRACT

The present invention discloses an electronic product and LOGO display method and system thereof, wherein, the LOGO display system comprises an IR emitting and sensing module, a LOGO projection module and a processing module. It emits an IR and detects an IR intensity reflected by a human body through the IR emitting and sensing module; then compares the IR intensity detected by the IR emitting and sensing module with a threshold through the processing module, controls the LOGO projection module to project the LOGO, when the IR intensity is larger than the threshold; it has achieved a personalized display for the LOGO, and attracted an attention from the user to the LOGO, which is more energy-saving and environment-friendly than the prior art of displaying the LOGO continuously after turning on the machine.

### CROSS-REFERENCES TO RELATED APPLICATIONS

This application is a national stage application of PCT Patent Application No. PCT/CN2016/070271, filed on Jan. 6, 2016, which claims priority to Chinese Patent Application No. 2015105647667, filed on Sep. 8, 2015, the content of all of which is incorporated herein by reference.

### FIELD OF THE INVENTION

The present invention relates to the field of home electrics, and, more particularly, to an electronic product and LOGO display method and system thereof.

### BACKGROUND

Currently, a display method of a LOGO (a logo or a trademark) of an electric industry product is mainly carved on a case of the product through a method of screen printing or inlaying, which looks a same, without a personality, it is very dull and can not indicate a noble and high end of the product. A display method of starting a LOGO display after powered on, and stopping the display after powered off, will not change according to a habit of a user, also, a color and a position of the LOGO may not be adjusted either, which has greatly reduced an advertisement effect of the LOGO, due to not eye-catching.

Therefore, the current technology of a LOGO displaying on an electronic product, especially on a TV set is not significant, the display technology needs to be improved and developed.

### BRIEF SUMMARY OF THE DISCLOSURE

According to the above described defects, the purpose of the present invention is providing an electronic product and logo display method and system thereof, when a human body is approaching to an electronic product, the LOGO is projected out, while the human body is leaving the electric product, the LOGO is stopped displaying, thus it has showed a personalized display, and attracted an attention of the user to the LOGO, as well as it is more energy saving and environment protecting.

In order to achieve the above mentioned goals, the technical solution of the present invention to solve the technical problems is as follows:

A LOGO display system for an electronic product, wherein, it comprises:

an Infrared ray (IR) emitting and sensing module, applied to emitting an IR and detecting an intensity of the IR reflected by a human body;

a LOGO projection module, applied to projecting a LOGO;

a processing module, applied to comparing the IR intensity detected by the IR emitting and sensing module with a threshold, and controlling the LOGO projection module to project the LOGO, when the IR intensity is larger than the threshold.

The LOGO display system for an electronic product, wherein, the LOGO projection module comprises a shell, in the shell, there are an LED light source, a first condenser lens, a film with the LOGO printed and a plurality of lenses arranged sequentially, a number of the plurality of lenses is N.

The LOGO display system for an electronic product, wherein, the processing module comprises:

a sampling unit, applied to sampling the IR intensity detected by the IR emitting and sensing module at every first preset period and getting the sampled values in a preset times of continuous sampling;

a comparison and control unit, applied to comparing the sampled values in the first preset times of sampling with the threshold, when the sampled values in a second preset times of continuous sampling are all larger than the threshold, the LOGO projection module is controlled to project the LOGO; otherwise, a current working status of the LOGO projection module is detected, if the LOGO projection module is projecting a LOGO, then the LOGO projection module is controlled to turn off the LOGO gradually;

the first preset times is larger than or equal to the second preset times.

The LOGO display system for an electronic product, wherein, the processing module further includes an initial value setting unit, the initial value setting unit is applied to obtaining a plurality of sampled values through the sampling unit, a number of the plurality of sampled values being equal to three timing a number of n (3×n), before dividing into three groups, and an average is taken from each group, followed by subtracting every two of the three averages, if each difference is not exceeding a first preset value, an average of the 3×n of sampled values is taken as an initial value; while the threshold equals to a sum of the initial value and the threshold.

The LOGO display system for an electronic product, wherein, the processing module further comprises an initial value adjustment unit, which is applied to obtaining an initial value from the initial value setting unit at every second preset period, which is compared with the last initial value, if their difference is not exceeding the second preset value, then the initial value is updated.

A LOGO display method for an electronic product adopting the LOGO display system of the electronic product, wherein, it comprises a plurality of steps of:

A, the IR emitting and sensing module emits the IR and detects the IR intensity reflected by the human body;

B, the processing module compares the IR intensity detected by the IR emitting and sensing module to the threshold, and controls the LOGO projection module to project the LOGO, when the IR intensity is larger than the threshold;

C, the LOGO projection module projects the LOGO.

The LOGO display method for an electronic product, wherein, the LOGO projection module comprises a shell, in the shell, there are a LED light source, a plurality of films with the LOGO printed and a plurality of lenses.

The LOGO display method for an electronic product, wherein, the step B further includes:
B1, the initial value setting unit obtains 3×n of sampled values through the sampling unit, before being divided into three groups, and an average is taken from each group, followed by subtracting every two of the three averages, if each difference is not exceeding a first preset value, an average of the 3×n of sampled values is taken as the initial value; while the threshold equals to a sum of the initial value and the threshold;
B2, the sampling unit samples the IR intensity detected by the IR emitting and sensing module at every first preset period and obtains the sampled values, while sampling continuously for the first preset times;
B3, the comparison and control unit compares the sampled values in the first preset times of sampling with the threshold, when the sampled values of the second preset times of continuous sampling are all larger than the threshold, the LOGO projection module is controlled to project the LOGO; otherwise, the current working status of the LOGO projection module is detected, if the LOGO projection module is projecting a LOGO, then the LOGO projection module is controlled to turn off the LOGO gradually;
the first preset times is larger than or equal to the second preset times.

The LOGO display method for an electronic product, wherein, the step B1 further includes: the initial value adjustment unit obtains an initial value from the initial value setting unit at every the second preset period, which is compared with the last initial value, if their difference is not exceeding the second preset value, then the initial value is updated.

An electronic product, wherein, it comprises the above said LOGO display system for an electronic product.

Comparing to the prior art, the present invention provides an electronic product and LOGO display method and system thereof, wherein, the LOGO display system comprises an IR emitting and sensing module, a LOGO projection module and a processing module. It emits an IR and detects an IR intensity reflected by a human body through the IR emitting and sensing module; then it compares the IR intensity detected by the IR emitting and sensing module with a threshold through the processing module, controls the LOGO projection module to project the LOGO, when the IR intensity is larger than the threshold; it has achieved a personalized display for the LOGO, and attracted an attention from the user to the LOGO, which is more energy-saving and environment-friendly than the prior art of displaying the LOGO continuously after turning on the machine.

### BRIEF DESCRIPTION OF THE DRAWINGS

FIG. 1 illustrates a block diagram of a LOGO display system of an electric product as provided in the present invention;

FIG. 2 illustrates a left view of an IR emitting and sensing module as provided in the present invention;

FIG. 3 illustrates a front view of an IR emitting and sensing module as provided in the present invention;

FIG. 4 illustrates a schematic diagram of a LOGO projection module as provided in the present invention;

FIG. 5 illustrates a flowchart on a LOGO display method of the electronic product as provided in the present invention.

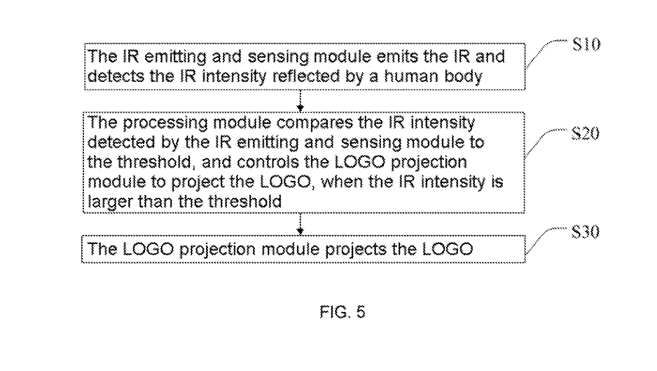

### DETAILED DESCRIPTION OF EMBODIMENTS

The present invention provides an electronic product and LOGO display method and system thereof, in order to make the purpose, technical solution and the advantages of the present invention clearer and more explicit, further detailed descriptions of the present invention are stated here, referencing to the attached drawings and some preferred embodiments of the present invention. It should be understood that the detailed embodiments of the invention described here are used to explain the present invention only, instead of limiting the present invention.

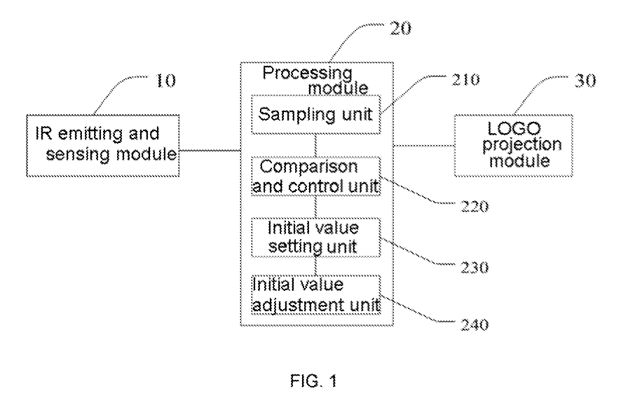

Referencing to FIG. 1, the present invention provides a LOGO display system for an electronic product, which comprises an IR emitting and sensing module 10, a processing module 20 and a LOGO projection module 30.

The IR emitting and sensing module 10 is applied to emitting an IR and detecting an intensity of an IR reflected by a human body. The IR emitting and sensing module 10 is preferably an IR sensor.

The LOGO projection module 30 is applied to projecting the LOGO. The LOGO includes a logo or a trademark.

The processing module 20, applied to comparing the detected IR intensity by the IR emitting and sensing module with a threshold, and controlling the LOGO projection module 30 to project the LOGO, when the IR intensity is larger than the threshold; and detects a current working status of the LOGO projection module 30, when the IR intensity is smaller than the threshold, if the LOGO projection module 30 is working (in a turned-on status), then the LOGO projection module 30 is controlled to turn off the LOGO gradually, if the LOGO projection module 30 is stopped working (in a turned-off status), then the LOGO projection module 30 is controlled to keep the current working status.

The threshold, preferably, is the IR intensity detected by the IR emitting and sensing module 10 when the human body is 60 cm away from a TV set.

The processing module 20 is preferably an MCU chip, the MCU chip mimics a PWM output with a GPIO, makes a duty ratio of the LOGO projection module 30 change from 100% to 0%, thus achieving turning off the LOGO gradually.

The LOGO display system of the electronic products provided in the present invention, may be applied to a plurality of electronic products, which includes a TV set, a displayer, a mobile terminal, a tablet, a plurality of various of home appliances, a printer and else, in the present embodiment, the electronic product is a TV set. When a user steps closer to a TV set comprising the LOGO display system, since the user reflects back most of the IR emitted by the IR emitting and sensing module 10, the IR emitting and sensing module 10 then detects the IR intensity reflected by the human body larger than the threshold, the processing module 20 then controls the LOGO projection module 30 to project the LOGO; accordingly, when the user is leaving the TV set, the IR reflected by the human body is decreasing, when the IR intensity is lower than the threshold, the processing module 20 then controls the LOGO projection module 30 to turn off the LOGO gradually. In such a way, the LOGO is displayed according to a distance from the user, thus a personalized display of the LOGO is achieved, which attracts an attention of the user to the LOGO, also, it is more energy saving and environment friendly than the prior arts of displaying the LOGO since the machine is on.

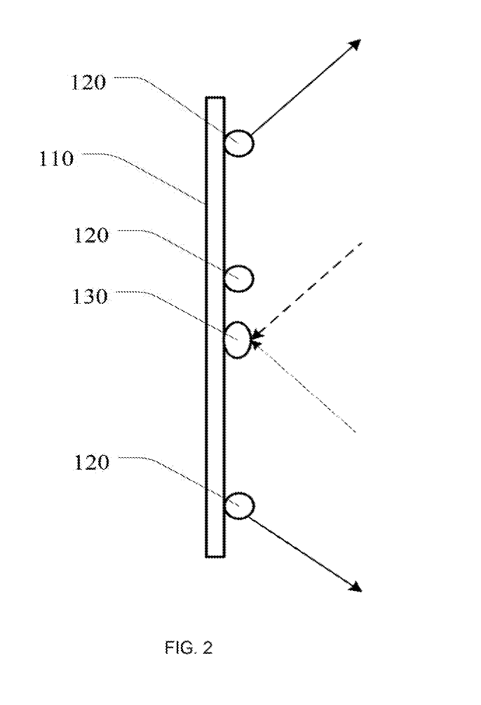

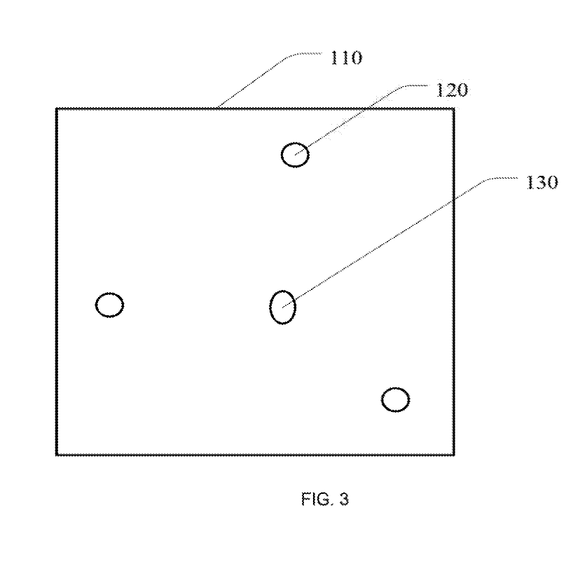

Referencing to FIGS. 2 and 3 together, the IR emitting and sensing module 10 comprises an IR sensor chip 110, three IR emitting diodes 120 and a IR receiving diode 130. The three IR emitting diodes 120 emit the IR, and the IR reflected by an outer object is received by the IR receiving diode 130. The IR sensor chip 110 converts the IR received by the IR receiving diode 130 into a current, which is further converted into a 16-bit-data (maximum 65535) by an integrated ASIC (Application Specific Integrated Circuit), before saving the data representing the IR intensity into a register. The IR emitting and sensing module 10 and the processing module 20 are connected by an I2C bus, the IR sensor chip 110 transmits the data saved in the register to the processing module 20 through the I2C bus.

The three IR emitting diodes 120 and one IR receiving diode 130 are all arranged on the IR sensor chip 110, wherein, the three IR emitting diodes 120 are distributed on three directions of up down and left of the IR receiving diode 130, in the present embodiment, the three IR emitting diodes 120 are distributed on three vertices of an equilateral triangle, the IR receiving diode 130 is arranged at the center of the equilateral triangle, such an arrangement makes a total emission range of the three IR emitting diodes 120 a maximum (as shown by a solid arrow in the FIG. 2). An angle of a receiving range of the IR receiving diode 130 is 110° (as shown by a dashed arrow in the FIG. 2).

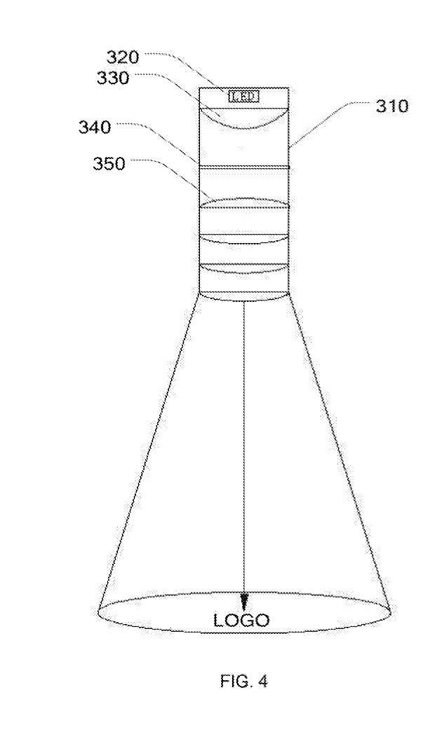

Referencing to FIG. 4, the LOGO projection module 30 comprises a shell 310, which is a cylindrical shell. In the shell 310, there are an LED light source 320, a first condenser lens 330, a film 340 with the LOGO printed and a plurality of lenses 350 arranged sequentially, a number of the plurality of lenses being equal to N. In other words, one end of the shell 310 has an LED light source 320 arranged, on a light path of the LED light source 320, there are a first condenser lens 330, applied to condensing the light emitted from the LED light source 320 into a parallel light, a film 340 with the LOGO printed and a plurality of lenses 350 applied to condensing the light passing through the film 340 into parallel light. The N is a positive integer; the number of the lens 350 is decided by the projection distance. In the present embodiment, the N is 4.

The LED light source 320 emits a light onto the first condenser lens 330, and the light passes the first condenser lens 330 before being refracted onto the film 340 having the LOGO printed, followed by passing through 4 lenses 350 sequentially, and finally projecting the LOGO onto a ground, a desktop, a wall or wherever the user wants to project.

Further, the LOGO projection module 30 may also include a reflection mirror being able to adjust a direction of the reflected light (not shown in the FIGs), the reflection mirror is arranged on other end of the shell 310 (the end through that the LOGO is projected out), applied to being able to adjust the reflection direction of the reflection mirror, before projecting the LOGO to wherever the user wants, it is very practical and convenient, and further achieving a personalized display.

It can be seen that, the LOGO display system in the electronic product as provided in the present invention, has broken a conventional thinking of printing the LOGO onto the shell of a machine through a method of silk screen or mosaic carving or else. It owns a simple installation method, a high brightness and a clear display of the LOGO. In this method, as long as the IR sensor receives the IR reflected back by the external objects (including the human body), it may project the LOGO onto the tabletop, when the external object is leaving, the LOGO projected onto the desktop is blackening gradually, before disappearing, which gives people a dynamic feeling, and greatly improves a feeling of science and technology, as well as mystery, making the display of the LOGO attractive.

Continue referencing to FIG. 1, the processing module 20 comprises a sampling unit 210, a comparison and control unit 220, an initial value setting unit 230 and an initial value adjustment unit 240.

The sampling unit 210 is applied to sampling the IR intensity detected by the IR emitting and sensing module 10 at every first preset period and getting the sampled values in a preset times of continuous sampling. The first preset period may be set according to a requirement, in the present embodiment, the first preset time is 4 ms. The first preset times may be set according to the requirement in the present embodiment; the first preset times is 16. The shorter the first preset period is, the more the first preset times is, and the more accurate the IR intensity being sampled by the sampling unit 210 is. Specifically, the sampling unit 210 makes a sampling to the values stored in the register in the IR sensor chip 110 in every 4 ms, and making 16 times of sampling totally.

The comparison and control unit 220, applied to comparing the sampled values in the first preset times of sampling with the threshold, when the sampled values of a second preset times of continuous sampling are all larger than the threshold, the LOGO projection module 30 is controlled to project the LOGO; otherwise, a current working status of the LOGO projection module 30 is detected, if the LOGO projection module 30 is projecting a LOGO (on a working state), then the LOGO projection module 30 is controlled to turn off the LOGO gradually; if the LOGO projection module 30 has stopped projecting the LOGO (on an off state), then the LOGO projection module 30 is controlled to keep the current working status.

In other words, the comparison and control unit 220 compares the sizes between the 16 sampled values and the threshold, and in the 16 sampled values, if a plurality of values from 10 continuous sampling are all larger than the threshold, which means the IR intensity is large and stable, then the comparison and control unit 220 controls the LOGO projection module 30 to project the LOGO. In the 16 sampled values, if there are no 10 continuous sampling values are all larger than the threshold, which means the IR intensity is varying and not stable, while the user is not approaching or has been far away from the TV set, thus the comparison and control unit 220 makes a next action according to the working status of the LOGO projection module 30, when the LOGO is being projected out, the LOGO projection module 30 is controlled to turn off the LOGO; when the LOGO is not being projected out, the LOGO projection module 30 is controlled keeping the off state.

The first preset times is larger than or equal to the second preset times. The second preset times may be set according to the requirements, the larger it is, the better it is able to exclude a plurality of outside interferences, preferably, the second preset times is 10 times.

It can be seen that, the comparison and control unit 220 excludes the outside interferences to the IR intensity detection through a selection of the second preset times, and ensures an accuracy of detecting an object approaching or leaving.

The initial value setting unit 230 is applied to obtaining a plurality of 3×n sampled values through the sampling unit 210, before being divided into three groups, and an average is taken from each group, followed by subtracting every two of the three averages, if each difference is not exceeding a first preset value, an average of the 3×n sampled values is taken as an initial value; while the threshold equals to a sum of the initial value and the threshold. The n is set according to requirements, which is a positive integer, preferably, the n=16. In other words, the initial value setting unit 230 reads the values in the register for 48 times continuously, before dividing the values into three groups, then takes average from each group (A, B and C), makes difference from each two of them, if the differences are satisfied not exceeding 5, that is, |Ā−B̅|<5,

|C̅−Ā|≦5, then the average of the three groups (the average of A, B and C) are taken as the initial value. By setting the initial values, it may exclude some interference from external IR. While setting the threshold, may help to recognize an approach of the human body, that is, the threshold may be set to little lower than the IR increased due to a human body approaching, thus it helps to detect a human body's approaching.

The initial value adjustment unit 240 is applied to obtaining an initial value from the initial value setting unit 230 at every a second preset period, which is compared with the last initial value, if their difference is not exceeding the second preset value, then the initial value is updated. In details, it is applied to updating the initial value every the second preset period, and if just to the second preset period, the working status of the LOGO projecting module 30 is changed, then the initial value will not be updated; if after the second preset period, the working status of the LOGO projecting module 30 is not changed, then an initial value from the initial value setting unit 230 at every the second preset period is obtained, which is compared with the last initial value, if their difference is not exceeding the second preset value, then the initial value is updated. Preferably, the second preset period is 1 minute; and the second preset value is 30.

It can be seen that, the initial value means the IR intensity detected by the IR emitting and sensing module 10, when there is no objects are approaching. Due to a change of the external environment, even there is no object is approaching the TV set, the IR around the TV set may also change, and an adjustment to the initial value has fitted the change, which makes the threshold change, thus has eliminated an effect from the extemal environment to the human body, and improved the accuracy of turning on and off the LOGO projecting.

All above, the present invention provides a LOGO display system for an electronic product, which has a relatively wide scope of application, and may be applied to all home electronic appliances need to display the LOGO. It combines three factors including IR sensing for human body approaching, film, LOGO displaying cleverly, so as to achieve that, when a human body steps into a certain distance from a TV set, the LOGO will be projected onto a desktop, when a human body is leaving from a distance of 60 cm from the TV set, the LOGO is turned off gradually. The protocol is easy to install, and the LOGO projection position or the projection color may be chosen by the user himself. The display of the LOGO is clear and bright, it owns a relatively large sensing range in an effective sensing distance, thus improves a technology feeling of the product, and helps to improve a high-end figure of the product, and improve a corporate figure indirectly.

Based on the LOGO display system of the electronic product as provided by the last embodiment, the present invention further provides a LOGO display method of the electronic product adopting the LOGO display system of the electronic product, wherein, it includes the following steps:

S10, the IR emitting and sensing module emits the IR and detects the IR intensity reflected by a human body.

S20, the processing module compares the IR intensity detected by the IR emitting and sensing module to the threshold, and controls the LOGO projection module 30 to project the LOGO, when the IR intensity is larger than the threshold.

S30, the LOGO projection module 30 projects the LOGO.

The LOGO projection module includes a shell, in the shell, there are the LED light source, films with the LOGO printed and a plurality of lenses.

The step S20 includes specifically:

S210, The initial value setting unit obtains a plurality of 3×n sampled values through the sampling unit, before being divided into three groups, and an average is taken from each group, followed by subtracting every two of the three averages, if each difference is not exceeding a first preset value, an average of the 3×n sampled values is taken as an initial value; while the threshold equals to the sum of the initial value and the threshold.

S220, The sampling unit samples the IR intensity detected by the IR emitting and sensing module at every first preset period and obtains the sampled values, while sampling continuously at the preset times;

S230, The comparison and control unit compares the sampled values in the first preset times of sampling with the threshold, when the sampled values of the second preset times of continuous sampling are all larger than the threshold, the LOGO projection module is controlled to project the LOGO; otherwise, the current working status of the LOGO projection module is detected, if the LOGO projection module is projecting a LOGO, then the LOGO projection module is controlled to turn off the LOGO gradually;

The first preset times is larger than or equal to the second preset times.

The step S210 further includes: the initial value adjustment unit obtains an initial value from the initial value setting unit at every a second preset period, which is compared with the last initial value, if their difference is not exceeding the second preset value, then the initial value is updated.

Since a feature and principle of the LOGO display method of the electronic product has been described in details in the last embodiment, thus the description thereof will not be repeated here.

The present invention further provides an electronic product, comprising the above said LOGO display system of the electronic product. Preferably, the electronic product is a TV set. Due to the feature and principle of the electronic product has been described in details in the last embodiment, thus the description thereof will not be repeated here.

It should be understood that, the application of the present invention is not limited to the above examples listed. Ordinary technical personnel in this field can improve or change the applications according to the above descriptions, all of these improvements and transforms should belong to the scope of protection in the appended claims of the present invention.

What is claimed is:

1. A LOGO display system for an electronic product, wherein, it comprises:
an IR emitting and sensing module, applied to emitting an IR and detecting an intensity of the IR reflected by a human body;
a LOGO projection module, applied to projecting a LOGO;
a processing module, applied to comparing the IR intensity detected by the IR emitting and sensing module with a threshold, and controlling the LOGO projection module to project the LOGO, when the IR intensity is larger than the threshold.

2. The LOGO display system for an electronic product according to claim 1, wherein, the LOGO projection module comprises a shell, in the shell, there are an LED light source, a first condenser lens, a film with the LOGO printed and a plurality of lenses arranged sequentially.

3. The LOGO display system for an electronic product according to claim 2, wherein, the processing module comprises:
a sampling unit, applied to sampling the IR intensity detected by the IR emitting and sensing module at every first preset period and getting the sampled values in a preset times of continuous sampling.
a comparison and control unit, applied to comparing the sampled values in the first preset times of sampling with the threshold, when the sampled values in a second preset times of continuous sampling are all larger than the threshold, the LOGO projection module is controlled to project the LOGO; otherwise, a current working status of the LOGO projection module is detected, if the LOGO projection module is projecting a LOGO, then the LOGO projection module is controlled to turn off the LOGO gradually;
the first preset times is larger than or equal to the second preset times.

4. The LOGO display system for an electronic product according to claim 3, wherein, the processing module further includes an initial value setting unit, the initial value setting unit is applied to obtaining a plurality of sampled values through the sampling unit, a number of the plurality of sampled values being equal to three timing a number of n (3×n), before being divided into three groups, and an average is taken from each group, followed by subtracting every two of the three averages, if each difference is not exceeding a first preset value, an average of the 3×n of sampled values is taken as an initial value; while the threshold equals to a sum of the initial value and the threshold.

5. The LOGO display system for an electronic product according to claim 4, wherein, the processing module further comprises an initial value adjustment unit, which is applied to obtaining an initial value from the initial value setting unit at every second preset period, which is compared with the last initial value, if their difference is not exceeding the second preset value, then the initial value is updated.

6. A LOGO display method for an electronic product adopting the LOGO display system of the electronic product, wherein, it comprises a plurality of steps of:
A, the IR emitting and sensing module emits the IR and detects the IR intensity reflected by the human body;
B, the processing module compares the IR intensity detected by the IR emitting and sensing module to the threshold, and controls the LOGO projection module to project the LOGO, when the IR intensity is larger than the threshold;
C, the LOGO projection module projects the LOGO.

7. The LOGO display method for an electronic product according to claim 6, wherein, the LOGO projection module comprises a shell, in the shell, there are a LED light source, a plurality of films with the LOGO printed and a plurality of lenses.

8. The LOGO display method for an electronic product according to claim 7, wherein, the step B further includes:
B1, the initial value setting unit obtains 3×n of sampled values through the sampling unit, before dividing into three groups, and taking an average from each group, followed by subtracting every two of the three averages, if each difference is not exceeding a first preset value, an average of the 3×n of sampled values is taken as the initial value; while the threshold equals to a sum of the initial value and the threshold;
B2, the sampling unit samples the IR intensity detected by the IR emitting and sensing module at every first preset period and obtains the sampled values, while sampling continuously for the first preset times;
B3, the comparison and control unit compares the sampled values in the first preset times of sampling with the threshold, when the sampled values of the second preset times of continuous sampling are all larger than the threshold, the LOGO projection module is controlled to project the LOGO; otherwise, the current working status of the LOGO projection module is detected, if the LOGO projection module is projecting a LOGO, then the LOGO projection module is controlled to turn off the LOGO gradually;
the first preset times is larger than or equal to the second preset times.

9. The LOGO display method for an electronic product according to claim 8, wherein, the step B1 further includes: the initial value adjustment unit obtains an initial value from the initial value setting unit at every the second preset period, which is compared with the last initial value, if their difference is not exceeding the second preset value, then the initial value is updated.

10. An electronic product, wherein, it comprises the LOGO display system for an electronic product according to claim 1, the LOGO display system for an electronic product includes:
an IR emitting and sensing module, applied to emitting an IR and detecting an intensity of an IR reflected by a human body;
a LOGO projection module, applied to projecting a LOGO;
a processing module, applied to comparing the detected IR intensity by the IR emitting and sensing module with a threshold, and controlling the LOGO projection module to project the LOGO, when the IR intensity is larger than the threshold.

11. The electronic product according to claim 10, wherein, the LOGO projection module comprises a shell, in the shell, there are an LED light source, a first condenser lens, a film with the LOGO printed and a plurality of lenses arranged sequentially.

12. The electronic product according to claim 10, wherein, the processing module comprises:
a sampling unit, applied to sampling the IR intensity detected by the IR emitting and sensing module at every first preset period and getting the sampled values in a preset times of continuous sampling.
a comparison and control unit, applied to comparing the sampled values in the first preset times of sampling with the threshold, when the sampled values in a second preset times of continuous sampling are all larger than the threshold, the LOGO projection module is controlled to project the LOGO; otherwise, a current working status of the LOGO projection module is detected, if the LOGO projection module is projecting a LOGO, then the LOGO projection module is controlled to turn off the LOGO gradually;
the first preset times is larger than or equal to the second preset times.

13. The electronic product according to claim 10, wherein, the processing module further includes an initial value setting unit, the initial value setting unit is applied to obtaining 3×n of sampled values through the sampling unit, before dividing into three groups, and an average is taken from each group, followed by subtracting every two of the three averages, if each difference is not exceeding a first preset value, an average of the 3×n of sampled values is taken as an initial value; while the threshold equals to a sum of the initial value and the threshold.

14. The electronic product according to claim 10, wherein, the processing module further comprises an initial value adjustment unit, which is applied to obtaining an initial value from the initial value setting unit at every second preset period, which is compared with the last initial value, if their difference is not exceeding the second preset value, then the initial value is updated.
